(19) United States
(12) Patent Application Publication
(10) Pub. No.: US 2024/0339819 A1
(43) Pub. Date: Oct. 10, 2024

(54) WIRE HARNESS

(71) Applicant: PROTERIAL, LTD., Tokyo (JP)

(72) Inventors: Hiroshi YAMADA, Tokyo (JP); Sinya OEDA, Tokyo (JP); Shingo HATAYAMA, Tokyo (JP)

(21) Appl. No.: 18/627,934

(22) Filed: Apr. 5, 2024

(30) Foreign Application Priority Data
Apr. 7, 2023 (JP) 2023-062824

(51) Int. Cl. H02G 3/04

(52) U.S. Cl. CPC H02G 3/04

(57) ABSTRACT

A wire harness includes a cable, a cover member, and a fixing member. The cable includes a covered portion in which the plurality of insulated electrical wires are covered with the outer sheath, and an exposed portion in which the plurality of insulated electrical wires are not covered with the outer sheath. The cover member includes a first tubular portion into which a part of the covered portion on a side of the exposed portion is inserted, and two or more second tubular portions branching and extending from an end part of the first tubular portion on a side of the exposed portion.

### CROSS-REFERENCE TO RELATED APPLICATIONS

The present application claims priority based on Japanese Patent Application No. 2023-062824 filed to Japanese Patent Office on Apr. 7, 2023, and the content of Japanese Patent Application No. 2023-062824 is incorporated herein by reference in its entirety.

### BACKGROUND

The present disclosure relates to a wire harness.

Japanese Patent Application Laid-Open Publication No. 2022-171718 describes a wire harness. As shown in FIG. 9A, the wire harness includes a cable 103. The cable 103 includes a plurality of insulated electrical wires 111 and 113 and an outer sheath 115. The outer sheath 115 covers the plurality of insulated electrical wires 111 and 113 except for an exposed portion 123 described later. The exposed portion 123 is formed at an end part of the cable 103. In the exposed portion 123, the plurality of insulated electrical wires 111 and 113 are not covered with the outer sheath 115. In the exposed portion 123, the insulated electrical wires 111 and 113 branch. In order to prevent chipping or the like due to flying stones, the insulated electrical wires 111 and 113 present in the exposed portion 123 are each covered with a protection material 125 including a tube or a hose.

As shown in FIG. 9B, a tape 127 is wound to fix the protection material 125. The tape 127 is wound from the side of the branching insulated electrical wires 111 and 113 up to the outer sheath 115.

### SUMMARY

In the conventional method, it is difficult to fix the protection material 125 because the tape 127 has to be wound over a wide range to fix the protection material 125. In one aspect of the present disclosure, it is preferable to provide a wire harness with which the cover member is easily fixed.

One aspect of the present disclosure is a wire harness including: a cable including a plurality of insulated electrical wires and an outer sheath; a cover member of an integrated type made of resin; and a fixing member that fixes the cover member to the cable.

The cable includes a covered portion in which the plurality of insulated electrical wires are covered with the outer sheath, and an exposed portion in which the plurality of insulated electrical wires are not covered with the outer sheath. The cover member includes a first tubular portion into which a part of the covered portion on a side of the exposed portion is inserted, and two or more second tubular portions branching and extending from an end part of the first tubular portion on a side of the exposed portion.

Two or more of the plurality of insulated electrical wires present in the exposed portion are inserted into the two or more second tubular portions, respectively. An inner peripheral surface of the first tubular portion is in contact with an outer peripheral surface of the covered portion inserted into the first tubular portion.

The fixing member is (a) a band attached to an outer peripheral side of the first tubular portion, (b) a tape wound around an outer peripheral surface of a specific part straddling the first tubular portion and the covered portion not inserted into the first tubular portion, (c) a shrink tube covering the specific part, or (d) a mold resin molded body covering the specific part.

With the wire harness of one aspect of the present disclosure, it is easy to fix the cover member.

### BRIEF DESCRIPTION OF THE DRAWINGS

Example embodiments of the present disclosure will be described hereinafter by way of example with reference to the accompanying drawings, in which:

FIG. 1 is a plan view showing a configuration of a wire harness in a first embodiment;

FIG. 2 is a cross-sectional view showing a II-II cross section in FIG. 1;

FIG. 3 is a side cross-sectional view showing a form of a cover member;

FIG. 4 is a plan view showing a configuration of a wire harness in a second embodiment;

FIG. 5 is a plan view showing a configuration of a wire harness in a third embodiment;

FIG. 6 is a plan view showing a configuration of a wire harness in a fourth embodiment;

FIG. 7 is a plan view showing a configuration of a cover member according to another embodiment;

FIG. 8 is a plan view showing a configuration of a cover member of another embodiment;

FIG. 9A is an explanatory view showing a configuration of a conventional wire harness in which each of branched insulated electrical wires is provided with a different protection material; and

FIG. 9B is an explanatory view showing a state in which a tape is wound to fix the protection material.

### DETAILED DESCRIPTION OF EXEMPLARY EMBODIMENTS

Exemplary embodiments of the present disclosure will be described with reference to the drawings.

### First Embodiment

### 1. Configuration of Wire Harness 1

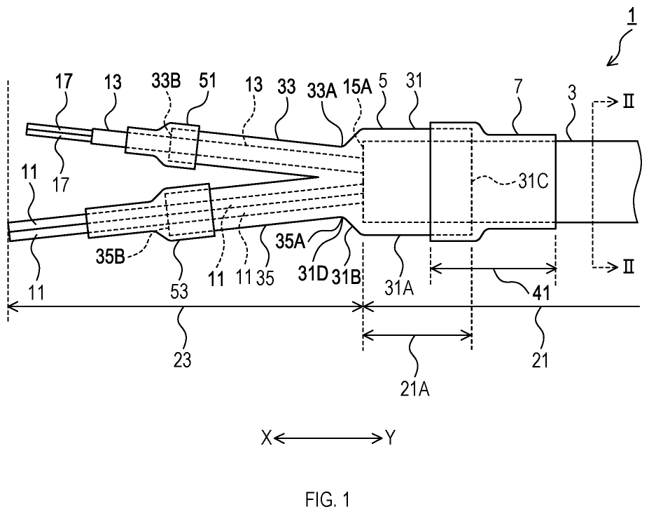

A configuration of a wire harness 1 will be described with reference to FIGS. 1 to 3. As shown in FIG. 1, the wire harness 1 includes a cable 3.

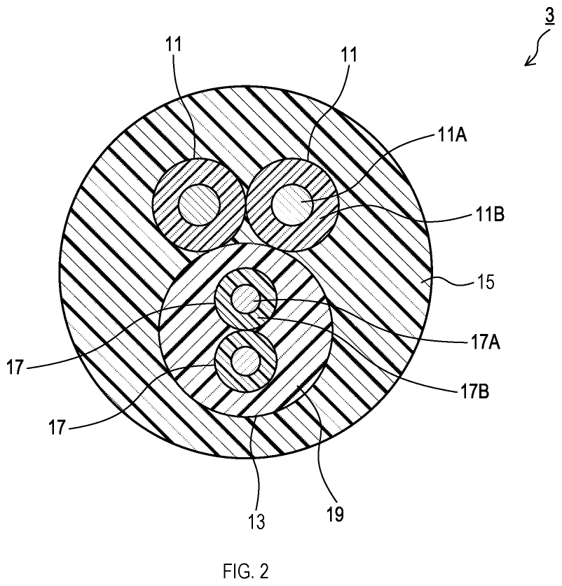

As shown in FIG. 2, the cable 3 includes two first electrical wires 11, one second electrical wire 13, and an outer sheath 15. The first electrical wire 11 includes a central conductor 11A and an insulator 11B. The insulator 11B covers the central conductor 11A.

The outer sheath 15 covers the first electrical wires 11 and the second electrical wire 13 except for an exposed portion 23 described later. The second electrical wire 13 includes two insulated electrical wires 17 and an inner sheath 19. The insulated electrical wire 17 includes a central conductor 17A and an insulator 17B. The insulator 17B covers the central conductor 17A. The inner sheath 19 covers the two insulated electrical wires 17. The two first electrical wires 11 and the two insulated electrical wires 17 correspond to a plurality of insulated electrical wires.

As shown in FIG. 1, the cable 3 includes a covered portion 21 and the exposed portion 23. The covered portion 21 is a part where the first electrical wires 11 and the second electrical wire 13 are covered with the outer sheath 15. FIG. 2 shows a cross section of the cable 3 in the covered portion 21.

The exposed portion 23 is formed at an end part of the cable 3. The exposed portion 23 is on the side of a direction X with reference to the covered portion 21. The direction X is a direction from the covered portion 21 toward the exposed portion 23. The direction X is parallel to an axial direction of the covered portion 21. The exposed portion 23 is a part where the outer sheath 15 is removed and the first electrical wires 11 and the second electrical wire 13 are not covered with the outer sheath 15.

As shown in FIG. 1, the wire harness 1 includes a cover member 5. The cover member 5 is a member of an integrated type made of resin. The integrated type means that an arbitrary part is physically connected to another part in the cover member 5. Examples of the material of the cover member 5 include urethane and rubber. The cover member 5 covers a part straddling the covered portion 21 and the exposed portion 23 of the cable 3.

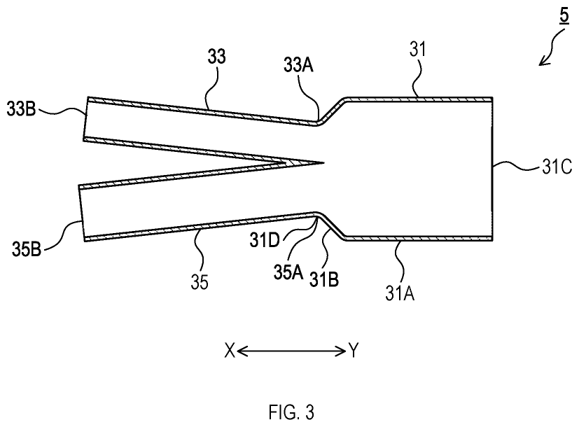

As shown in FIGS. 1 and 3, the cover member 5 includes one first tubular portion 31. The first tubular portion 31 is a part present on the side of a direction Y in the cover member 5. The direction Y is a direction opposite to the direction X.

The first tubular portion 31 is a hollow cylindrical portion. An axial direction of the first tubular portion 31 is parallel to the direction X and the direction Y. An end part of the first tubular portion 31 on the side of the direction Y is denoted with 31C. An end part of the first tubular portion 31 on the side of the direction X is denoted with 31D. The space inside the first tubular portion 31 is continuous from the end part 31C to the end part 31D. The first tubular portion 31 is open at the end parts 31C and 31D. The number of openings at the end part 31C is only one. The number of openings at the end part 31D is only one.

The first tubular portion 31 includes a large diameter part 31A and a reduced diameter part 31B. The reduced diameter part 31B is present on the side of the direction X relative to the large diameter part 31A. The inner diameter of the large diameter part 31A is constant regardless of the position in the directions X and Y. The inner diameter at the end part of the reduced diameter part 31B on the side of the direction Y is the same as the inner diameter of the large diameter part 31A. The inner diameter of the reduced diameter part 31B decreases as it advances in the direction X.

Since the first tubular portion 31 is open at the end part 31C, the inside and outside of the first tubular portion 31 communicate with each other via the end part 31C. The inner diameter of the opening at the end part 31C is the same as the inner diameter of the large diameter part 31A.

As shown in FIG. 1, a part of the covered portion 21 on the side of the direction X (hereinafter, insertion portion 21A) is inserted into the large diameter part 31A. An inner peripheral surface of the large diameter part 31A is in contact with an outer peripheral surface of the insertion portion 21A. Since the inner peripheral surface of the large diameter part 31A is in contact with the outer peripheral surface of the insertion portion 21A, it is possible to suppress water from entering from between the inner peripheral surface of the large diameter part 31A and the insertion portion 21A. An end part 15A of the outer sheath 15 on the side of the direction X is in contact with an inner peripheral surface of the reduced diameter part 31B.

As shown in FIGS. 1 and 3, the cover member 5 includes two second tubular portions 33 and 35. Each of the second tubular portions 33 and 35 is a hollow cylindrical portion. The second tubular portions 33 and 35 branch and extend from the end part 31D of the first tubular portion 31. That is, an interval between the second tubular portion 33 and the second tubular portion 35 increases as it advances in the direction X.

An end part of the second tubular portion 33 on the side of the direction Y is denoted with 33A. An end part of the second tubular portion 33 on the side of the direction X is denoted with 33B. The second tubular portion 33 is open at the end parts 33A and 33B. Therefore, as shown in FIG. 3, an inside of the second tubular portion 33 communicates with the inside of the first tubular portion 31 via the end part 33A. The inside and an outside of the second tubular portion 33 communicate with each other via the end part 33B.

An end part of the second tubular portion 35 on the side of the direction Y is denoted with 35A. An end part of the second tubular portion 35 on the side of the direction X is denoted with 35B. The second tubular portion 35 is open at the end parts 35A and 35B. Therefore, as shown in FIG. 3, an inside of the second tubular portion 35 communicates with the inside of the first tubular portion 31 via the end part 35A. The inside and an outside of the second tubular portion 35 communicate with each other via the end part 35B.

As shown in FIG. 1, the second electrical wire 13 present in the exposed portion 23 is inserted into the second tubular portion 33. The second electrical wire 13 is inserted into the second tubular portion 33 from the end part 33A, advances in the direction of the end part 33B in the second tubular portion 33, and protrudes from the end part 33B. The inner sheath 19 is removed at a tip end of the part of the second electrical wire 13 protruding from the end part 33B, and the two insulated electrical wires 17 are exposed. The two insulated electrical wires 17 correspond to the plurality of insulated electrical wires.

As shown in FIG. 1, the two first electrical wires 11 present in the exposed portion 23 are inserted into the second tubular portion 35. The two first electrical wires 11 are inserted into the second tubular portion 35 from the end part 35A, advance in the direction of the end part 35B in the second tubular portion 35, and protrude from the end part 35B. By inserting the plurality of insulated electrical wires into each of the second tubular portions 33 and 35, it is possible to suppress flaws from occurring in the plurality of insulated electrical wires inserted into each of the second tubular portions 33 and 35. Examples of the flaws include a flaw caused by a flying stone.

As shown in FIG. 1, the wire harness 1 includes a fixing member 7. In the present embodiment, the fixing member 7 is a shrink tube. The fixing member 7 covers a specific part 41 shown in FIG. 1 from an outer peripheral side. The specific part 41 is a part straddling the first tubular portion 31 and the covered portion 21 not inserted into the first tubular portion 31. More specifically, the specific part 41 includes a part of the first tubular portion 31 on the side of the direction Y. The specific part 41 includes a part of the covered portion 21 that is not inserted into the first tubular portion 31 and is present on the side of the direction X. The fixing member 7 is made of a heat-shrinkable resin. Examples of the heat-shrinkable resin include polyolefins, fluoropolymers, and thermoplastic elastomers. The shrink tube comes into close contact with the specific part 41 by thermal shrinkage.

As shown in FIG. 1, the wire harness 1 includes fixing members 51 and 53. The fixing members 51 and 53 are shrink tubes. The fixing member 51 covers a part straddling a part of the second tubular portion 33 on the side of the end part 33B and the second electrical wire 13 protruding from the end part 33B. The fixing member 53 covers a part straddling a part of the second tubular portion 35 on the side of the end part 35B and the first electrical wire 11 protruding from the end part 35B. Examples of the material of the fixing members 51 and 53 include materials similar to the material of the fixing member 7.

### 2. Effects Exerted by Wire Harness 1

(1A) The wire harness 1 includes the cover member 5 and the fixing member 7. By covering the specific part 41, the fixing member 7 fixes the cover member 5 to the cable 3. In the wire harness 1, the cover member 5 can be easily fixed as compared with the conventional method in which the separate protection materials 125 are attached to the plurality of insulated electrical wires 111 and 113 and the protection materials 125 are fixed with the tape 127.

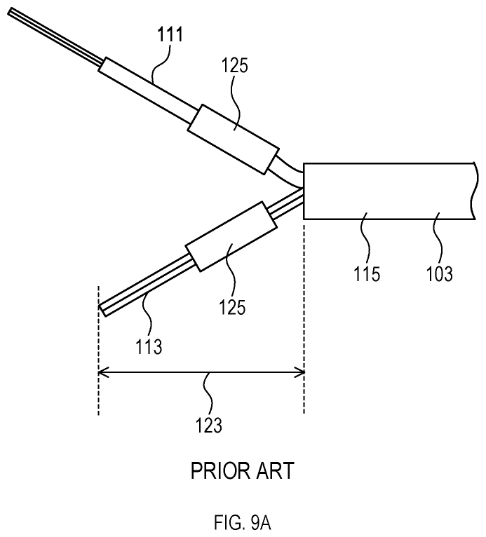

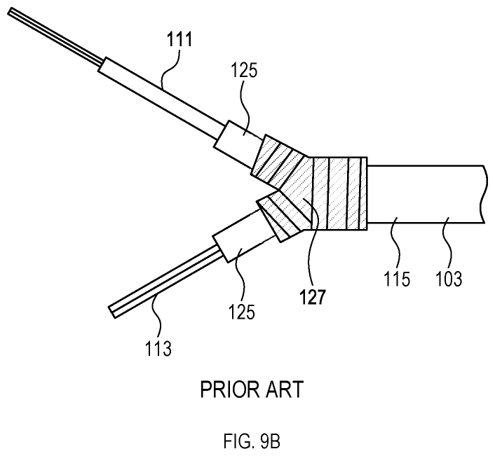

(1B) In the conventional wire harness, as shown in FIG. 9A, the separate protection materials 125 are attached to the plurality of insulated electrical wires 111 and 113. In that case, a gap easily occurs between the protection materials 125. A gap easily occurs between the protection material 125 and the outer sheath 115.

On the other hand, the cover member 5 is a member of an integrated type covering a part straddling the covered portion 21 and the exposed portion 23. Therefore, generation of the gap can be suppressed.

(1C) The fixing member 7 is a shrink tube. Therefore, it is possible to further suppress water from entering through a gap between the cover member 5 and the outer sheath 15.

(1D) The wire harness 1 includes the fixing members 51 and 53. The fixing members 51 and 53 are shrink tubes. Therefore, it is possible to suppress water from entering through a gap between the second tubular portion 33 and the second electrical wire 13. It is possible to suppress water from entering through a gap between the second tubular portion 35 and the first electrical wires 11.

### Second Embodiment

1. Difference from First Embodiment

Since the basic configuration of the second embodiment is similar to that of the first embodiment, differences will be described below. Note that the same reference numerals as those in the first embodiment indicate the identical configuration, and reference is made to the preceding description.

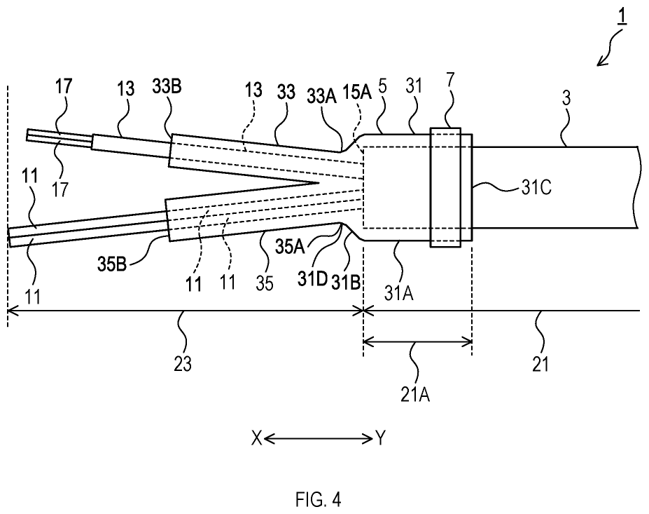

In the first embodiment described above, the fixing member 7 is a shrink tube. In the second embodiment, as shown in FIG. 4, the fixing member 7 is a band. The fixing member 7 has the shape of a belt. The fixing member 7 is attached to the outer peripheral side of the first tubular portion 31. The fixing member 7 is wound around the entire circumference along an outer peripheral surface of the first tubular portion 31. By tightening the fixing member 7, the cover member 5 shrinks radially inward and is strongly pressed against the covered portion 21. As a result, the cover member 5 is fixed to the cable 3. The material of the fixing member 7 is not particularly limited. Examples of the material of the fixing member 7 include nylon, polypropylene, and fluororesin. In the present embodiment, the wire harness 1 does not include the fixing members 51 and 53.

### 2. Effects Exerted by Wire Harness 1

According to the second embodiment described above in detail, the effects (1A) and (1B) of the first embodiment described above are achieved, and a following effect is further achieved.

(2A) Since the fixing member 7 is a band, the first tubular portion 31 can be more firmly fixed.

### Third Embodiment

1. Difference from First Embodiment

Since the basic configuration of the third embodiment is similar to that of the first embodiment, differences will be described below. Note that the same reference numerals as those in the first embodiment indicate the identical configuration, and reference is made to the preceding description.

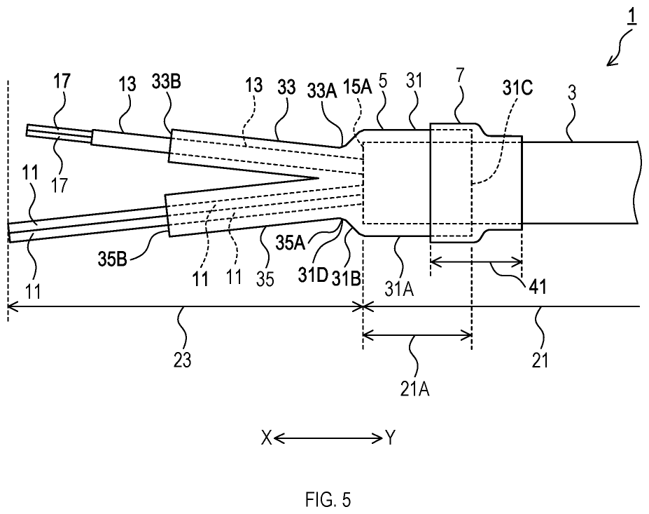

In the first embodiment described above, the fixing member 7 is a shrink tube. In the third embodiment, as shown in FIG. 5, the fixing member 7 is a tape. The fixing member 7 is wound around an outer peripheral surface of the specific part 41. The winding method of the fixing member 7 is not particularly limited. Examples of the winding method of the fixing member 7 include lap winding and longitudinal winding. Examples of the material of the tape include polyvinyl chloride (PVC). The tape has a structure in which, for example, a body layer made of resin and an adhesive layer are laminated. Due to the adhesive force of the adhesive layer, the tape adheres to the cover member 5 and the covered portion 21. In the present embodiment, the wire harness 1 does not include the fixing members 51 and 53.

### 2. Effects Exerted by Wire Harness 1

According to the third embodiment described above in detail, the effects (1A) and (1B) of the first embodiment described above are achieved, and a following effects is further achieved.

(3A) Since the fixing member 7 is a tape, the first tubular portion 31 can be more firmly fixed.

### Fourth Embodiment

1. Difference from First Embodiment

Since the basic configuration of the fourth embodiment is similar to that of the first embodiment, differences will be described below. Note that the same reference numerals as those in the first embodiment indicate the identical configuration, and reference is made to the preceding description.

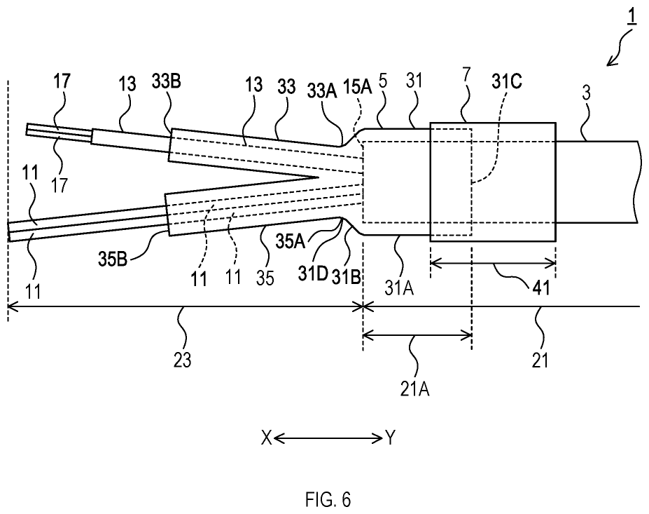

In the first embodiment described above, the fixing member 7 is a shrink tube. In the fourth embodiment, as shown in FIG. 6, the fixing member 7 is a mold resin molded body. The fixing member 7 covers the specific part 41. Examples of the material of the mold resin molded body include urethane, polybutylene terephthalate (PBT), and polyamide (PA). In the present embodiment, the wire harness 1 does not include the fixing members 51 and 53.

### 2. Effects Exerted by Wire Harness 1

According to the fourth embodiment described above in detail, the effects (1A) and (1B) of the first embodiment described above are achieved, and following effects are further achieved.

(4A) Since the fixing member 7 is a mold resin molded body, the first tubular portion 31 can be more firmly fixed. It is possible to suppress water from entering from between the fixing member 7 and the first tubular portion 31.

(4B) For example, the cover member 5, the outer sheath 15, and the fixing member 7 are made of the same material. Examples of the same material include urethane. In a case where the cover member 5, the outer sheath 15, and the fixing member 7 are made of the same material, when the fixing member 7 is molded by mold resin, the cover member 5 and the fixing member 7 are welded to each other, and the outer sheath 15 and the fixing member 7 are welded to each other. As a result, waterproofness of the wire harness 1 is further improved.

### Other Embodiments

Although embodiments of the present disclosure have been described above, the present disclosure is not limited to the above-described embodiments, and can be carried out in various modifications.

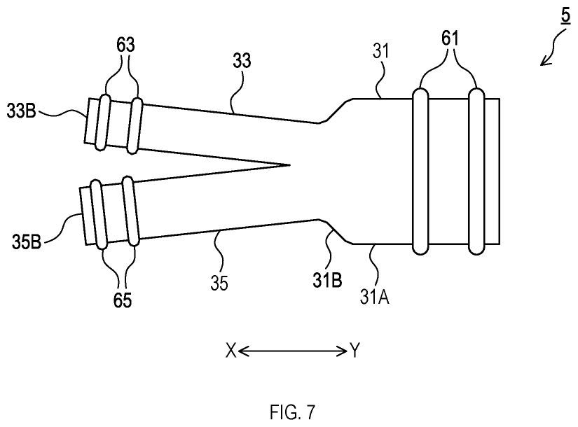

(1) In the first to fourth embodiments, the form of the cover member 5 may be as shown in FIG. 7. The cover member 5 includes two or more protrusion parts 61 on the outer peripheral surface of the first tubular portion 31. The protrusion part 61 is a part protruding radially outward relative to the periphery thereof. The protrusion part 61 extends along a circumferential direction of the first tubular portion 31. The protrusion part 61 is formed over the entire circumference of the first tubular portion 31. The two or more protrusion parts 61 are arranged at an interval or intervals in the directions X and Y.

The cover member 5 includes two or more protrusion parts 63 on an outer peripheral surface of the second tubular portion 33. The protrusion part 63 is a part protruding radially outward relative to the periphery thereof. The protrusion part 63 extends along a circumferential direction of the second tubular portion 33. The protrusion part 63 is formed over the entire circumference of the second tubular portion 33. The two or more protrusion parts 63 are arranged at an interval or intervals in the axial direction of the second tubular portion 33. The two or more protrusion parts 63 are formed on the side of end part 33B of the second tubular portion 33.

The cover member 5 includes two or more protrusion parts 65 on an outer peripheral surface of the second tubular portion 35. The protrusion part 65 is a part protruding radially outward relative to the periphery thereof. The protrusion part 65 extends along a circumferential direction of the second tubular portion 35. The protrusion part 65 is formed over the entire circumference of the second tubular portion 35. The two or more protrusion parts 65 are arranged at an interval or intervals in the axial direction of the second tubular portion 35. The two or more protrusion parts 65 are formed on the side of end part 35B of the second tubular portion 35.

For example, in a case where the fixing member 7 is a shrink tube, a tape, or a mold resin molded body, it is preferable that the protrusion part 61 be formed in the specific part 41. In this case, due to existence of the protrusion part 61 inside the fixing member 7, the fixing member 7 becomes less likely to come off from the first tubular portion 31.

In a case where the fixing member 7 is a band, it is preferable to wind the band between the two protrusion parts 61. In this case, due to existence of the protrusion parts 61 on both sides of the band, the fixing member 7 becomes less likely to come off from the first tubular portion 31.

For example, the fixing member 51 is preferably attached to the outer peripheral side of a range including the protrusion part 63. In this case, due to existence of the protrusion part 63 inside the fixing member 51, the fixing member 51 becomes less likely to come off from the second tubular portion 33.

For example, the fixing member 53 is preferably attached to the outer peripheral side of a range including the protrusion part 65. In this case, due to existence of the protrusion part 65 inside the fixing member 53, the fixing member 53 becomes less likely to come off from the second tubular portion 35.

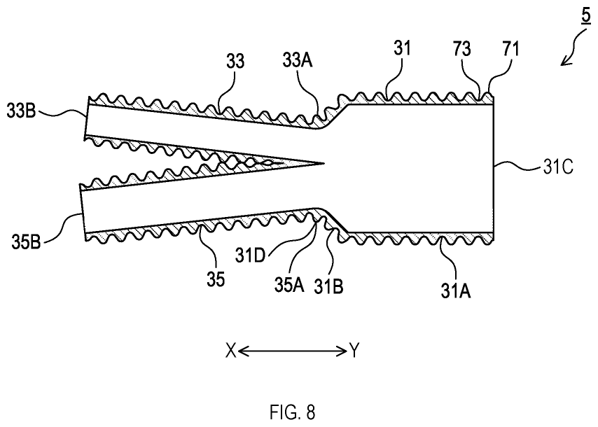

(2) In the first to fourth embodiments, the form of the cover member 5 may be as shown in FIG. 8. A plurality of protrusion parts 71 and a plurality of recess parts 73 are formed over the entire outer peripheral surface of the cover member 5. The protrusion part 71 is a part protruding radially outward relative to the periphery thereof. The recess part 73 is a part recessed radially inward relative to the periphery thereof.

The protrusion part 71 extends along a circumferential direction. The protrusion part 71 is formed over the entire circumference in the circumferential direction. The recess part 73 extends along the circumferential direction. The recess part 73 is formed over the entire circumference in the circumferential direction. The protrusion parts 71 and the recess parts 73 are alternately arrayed in the axial direction of the cover member 5.

Since the cover member 5 includes the protrusion parts 71 and the recess parts 73, it can be easily bent. Since the cover member 5 includes the protrusion parts 71 and the recess parts 73, the fixing members 7, 51, and 53 become less likely to come off from the cover member 5.

(3) The function of one component in each of the above embodiments may be shared by a plurality of components, or the function of a plurality of components may be exerted by one component. A part of the configuration of each of the above embodiments may be omitted. At least a part of the configuration of each of the above embodiments may be added to, replaced with, or the like with respect to the configuration of another of the above embodiments.

For example, the wire harness 1 of the second to fourth embodiments may include the fixing members 51 and 53 similarly to the first embodiment. The fixing members 51 and 53 may be a tape, a band, or a mold resin molded body.

(4) The present disclosure can be achieved in various forms such as a system with the wire harness 1 as a component and a manufacturing method of the wire harness 1 in addition to the wire harness 1 described above.

What is claimed is:

1. A wire harness comprising:
a cable including a plurality of insulated electrical wires and an outer sheath;
a cover member of an integrated type made of resin; and
a fixing member that fixes the cover member to the cable, wherein
the cable includes a covered portion in which the plurality of insulated electrical wires are covered with the outer sheath, and an exposed portion in which the plurality of insulated electrical wires are not covered with the outer sheath,
the cover member includes a first tubular portion into which a part of the covered portion on a side of the exposed portion is inserted, and
two or more second tubular portions branching and extending from an end part of the first tubular portion on a side of the exposed portion,
two or more of the plurality of insulated electrical wires present in the exposed portion are inserted into the two or more second tubular portions, respectively,
an inner peripheral surface of the first tubular portion is in contact with an outer peripheral surface of the covered portion inserted into the first tubular portion, and
the fixing member is (a) a band attached to an outer peripheral side of the first tubular portion, (b) a tape wound around an outer peripheral surface of a specific part straddling the first tubular portion and the covered portion not inserted into the first tubular portion, (c) a shrink tube covering the specific part, or (d) a mold resin molded body covering the specific part.

2. The wire harness according to claim 1 further comprising:
two or more protrusion parts extending along a circumferential direction of the first tubular portion on an outer peripheral surface of the first tubular portion.

3. The wire harness according to claim 1, wherein
an outer peripheral surface of at least one of the first tubular portion or the second tubular portion has a shape in which protrusion parts extending in a circumferential direction and recess parts extending in the circumferential direction are alternately arranged in an axial direction.

4. The wire harness according to claim 2, wherein
an outer peripheral surface of at least one of the first tubular portion or the second tubular portion has a shape in which protrusion parts extending in a circumferential direction and recess parts extending in the circumferential direction are alternately arranged in an axial direction.
